(19) United States
(12) Patent Application Publication
(10) Pub. No.: US 2024/0326124 A1
(43) Pub. Date: Oct. 3, 2024

(54) COMPOSITE COPPER NANOPARTICLES, AND METHOD FOR PRODUCING COMPOSITE COPPER NANOPARTICLES

(71) Applicant: TAIYO NIPPON SANSO CORPORATION, Tokyo (JP)

(72) Inventors: Katsunori TAKADA, Tokyo (JP); Naoya YAMAWAKI, Tokyo (JP); Hiroshi IGARASHI, Tokyo (JP); Noboru SUZUKI, Utsunomiya-shi (JP)

(21) Appl. No.: 18/580,003

(22) PCT Filed: Jul. 12, 2022
(86) PCT No.: PCT/JP2022/027404

§ 371 Date: Jan. 17, 2024

(30) Foreign Application Priority Data
Jul. 19, 2021 (JP) 2021-118673

(51) Int. Cl. B22F 1/0545; B22F 1/102; B22F 9/20

(52) U.S. Cl. CPC B22F 1/0545; B22F 1/102; B22F 9/20; B22F 2301/10; B22F 2302/25; B22F 2302/45; B22F 2304/054

(57) ABSTRACT

The present invention provides composite copper nanoparticles that have high dispersibility in organic solvents, have little thermal shrinkage even when sintered at 300° C. or higher, and can form smooth electrode films. The present invention provides composite copper nanoparticles in which the surface of the copper nanoparticles is modified with a silane coupling agent, wherein the copper nanoparticles have a film containing cuprous oxide and copper carbonate on at least a part of the surface, wherein when the entire composite copper nanoparticles are taken as 100% by mass, a mass carbon concentration is 0.5 to 1.5% by mass, wherein a mass carbon concentration caused by the silane coupling agent in the mass carbon concentration is 0.5 to 1.2% by mass, and wherein when a total mass of the composite copper nanoparticles is 100% by mass, a mass silicon concentration is in a range from 0.05 to 0.11% by mas

### TECHNICAL FIELD

The present invention relates to composite copper nanoparticles and a method for producing composite copper nanoparticles.

### BACKGROUND ART

Patent Document 1 discloses a method for improving the dispersibility of copper nanoparticles by modifying the surface of the copper nanoparticles with a silane coupling agent having a vinyl group, and then reacting with a monomer to form a graft polymer chain. However, in examples of Patent Document 1, the proportion of polymer chains is high at 2.8 to 7.0% by weight, and carbon residue tends to remain during producing an electrode film. For this reason, there is a concern that the adhesion of the electrode film may be impaired or conductivity may be poor.

Patent Document 2 discloses a method for modifying the surface of copper hydride fine particles which are synthesized by a wet method using a silane coupling agent. However, since copper fine particles synthesized by a wet method have a small crystallite size relative to the particle diameter, there is a concern that the electrode film may be distorted or peeled off due to thermal shrinkage during producing the electrode film.

### PRIOR ART DOCUMENTS

### Patent Documents

Patent Document 1: Japanese Patent No. 6686567
Patent Document 2: Japanese Unexamined Patent Application, First Publication No. 2015-110682

### SUMMARY OF INVENTION

### Problem to be Solved by the Invention

The present invention was made in view of the circumstances above, and an object of the present invention is to provide composite copper nanoparticles that have high dispersibility in organic solvents, have little thermal shrinkage even when sintered at 300° C. or higher, and can form smooth electrode films, and a method for producing the composite copper nanoparticles.

### Means for Solving the Problem

The present invention has the following aspects.

[1] Composite copper nanoparticles in which a surface of copper nanoparticles is modified with a silane coupling agent,
wherein the copper nanoparticles have a film containing cuprous oxide and copper carbonate on at least a part of the surface thereof,
wherein when a total mass of the composite copper nanoparticles is 100% by mass, a mass carbon concentration is in a range from 0.5 to 1.5% by mass,
wherein a mass carbon concentration caused by the silane coupling agent in the mass carbon concentration is in a range from 0.5 to 1.2% by mass, and
wherein when a total mass of the composite copper nanoparticles is 100% by mass, a mass silicon concentration is in a range from 0.05 to 0.11% by mass.

[2] The composite copper nanoparticles according to [1], wherein a mass carbon concentration caused by the copper nanoparticles in the mass carbon concentration is 0.3% by mass or less.

[3] The composite copper nanoparticles according to [1] or [2], wherein the silane coupling agent has an alkyl chain having 10 or more carbon atoms.

[4] The composite copper nanoparticles according to any one of [1] to [3], wherein an average particle diameter of the copper nanoparticles is 200 nm or less.

[5] A method for producing composite copper nanoparticles by modifying the surface of the copper nanoparticles with a silane coupling agent,
the method comprising:
a copper nanoparticles preparation step in which copper nanoparticles having a film containing cuprous oxide and copper carbonate on at least a part of the surface are prepared;
a dispersion step in which a dispersion liquid in which the copper nanoparticles are dispersed in an organic solvent is prepared; and
a reaction step in which a silane coupling agent is added into the dispersion liquid.

[6] The method for producing composite copper according to [5],
wherein an amount of the silane coupling agent added is 0.6 to 1.25 times an amount equivalent to forming a monolayer film on the surface of the copper nanoparticles.

### Effects of the Invention

The composite copper nanoparticles of the present invention have high dispersibility in organic solvents, have little thermal shrinkage even when sintered at 300° C. or higher, and can form a smooth electrode film.

The method for producing composite copper nanoparticles of the present invention provides composite copper nanoparticles that have high dispersibility in organic solvents, have little thermal shrinkage even when sintered at 300° C. or higher, and can form a smooth electrode film.

### BRIEF DESCRIPTION OF DRAWINGS

FIG. 1 is a graph showing the relationship between an amount of a silane coupling agent added and a surface roughness Rz in Examples of the present invention.

FIG. 2 is a graph showing the relationship between a number of carbon atoms in an alkyl chain of a silane coupling agent and a surface roughness Rz in Examples of the present invention.

FIG. 3 is a graph showing the relationship between a mass carbon concentration of copper nanoparticles and a surface roughness Rz in Examples of the present invention.

### DETAILED DESCRIPTION OF THE PREFERRED EMBODIMENTS

The meanings and definitions of terms used in the present description are as follows.

The numerical range represented by “˜” means a numerical range of which lower and upper limits are the numbers before and after ˜.

Modification of the surface of copper nanoparticles with a silane coupling agent means that hydroxyl groups present on the surface of the copper nanoparticles and the silane coupling agent undergo a dehydration condensation reaction, and silanol is bonded to the surface of the copper nanoparticles. Alternatively, even if there are no hydroxyl groups, silanol groups which are produced by hydrolyzing the alkoxy groups of the silane coupling agent due to electrostatic interaction are adsorbed onto the surface of the copper nanoparticles, and a monomolecular film is then formed on the surface of the copper nanoparticles by subsequent dehydration condensation between the silane coupling agents.

### <Composite Copper Nanoparticles>

The composite copper nanoparticles of the present invention are composite copper nanoparticles in which a surface of the copper nanoparticles is modified with a silane coupling agent, wherein the copper nanoparticles have a film containing cuprous oxide and copper carbonate on at least a part of the surface thereof, wherein when a total mass of the composite copper nanoparticles is 100% by mass, a mass carbon concentration is in a range from 0.5 to 1.5% by mass, wherein a mass carbon concentration caused by the silane coupling agent in the mass carbon concentration is in a range from 0.5 to 1.2% by mass, and wherein when a total mass of the composite copper nanoparticles is 100% by mass, a mass silicon concentration is in a range from 0.05 to 0.11% by mass.

### (Copper Nanoparticles)

The copper nanoparticles have a film containing cuprous oxide and copper carbonate on at least a part of the surface thereof. Examples of such copper nanoparticles include those manufactured by a dry method using a reduction flame. Copper nanoparticles produced by a dry method have little thermal shrinkage even when sintered at 300° C. or higher. In contrast, copper nanoparticles produced by a wet method have large thermal shrinkage.

The average particle diameter of the copper nanoparticles is preferably 10 nm or more and 200 nm or less, and more preferably 10 nm or more and 150 nm or less. When the average particle diameter of the copper nanoparticles is 200 nm or less, the composite copper nanoparticles have excellent dispersibility when made into a paste, and when it is 150 nm or less, the dispersibility is better exhibited. On the other hand, when the average particle diameter of the copper nanoparticles exceeds 200 nm, the weight per particle increases, the steric effect due to the alkyl chain of the silane coupling agent does not function sufficiently, and the dispersibility tends decrease when the composite copper nanoparticles are made into a paste.

### [Average Particle Diameter]

The average particle diameter of the copper nanoparticles can be measured using a scanning electron microscope (SEM). For example, the particle diameter of 250 copper nanoparticles present in one field of view in an electron microscope image is measured, and the number-average value is calculated and used as the average particle diameter of the copper nanoparticles.

Here, the criteria for selecting particles to be measured from among the particles shown in the image (photograph) of a scanning electron microscope are as follows (1) to (6).

(1) Particles that partially protrude outside the field of view of the photograph are not measured.

(2) Particles with clear outlines and isolated particles are measured.

(3) Even if the particle shape deviates from the average particle shape, particles that are independent and can be measured as individual particles are measured.

(4) If the particles overlap, but the boundary between the particles is clear and the shape of the entire particle can be determined, each particle is measured as a single particle.

(5) Particles that overlap, the boundary between the particles is unclear, and of which the entire shape cannot be determined are not measured since the shape of the particles cannot be determined.

(6) If the particles are not perfect circles, such as ellipses, the major axis is taken as the particle diameter.

The surface of the copper nanoparticles is covered with the film containing cuprous oxide and copper carbonate. The cuprous oxide in the film functions as a reaction site with the silane coupling agent.

On the other hand, the copper carbonate does not react with the silane coupling agent.

Therefore, it is preferable that the mass carbon concentration caused by the copper nanoparticles be 0.3% by mass or less.

### [Mass Carbon Concentration]

The mass carbon concentration in the copper nanoparticles and the composite copper nanoparticles described below can be measured using a carbon-sulfur analyzer (for example, “EMIA-920V” manufactured by Horiba, Ltd.). The mass carbon concentration in the copper nanoparticles and the composite copper nanoparticles is the number-average value of three samples.

### (Silane Coupling Agent)

The silane coupling agent used is not particularly limited as long as it can be chemically bonded to the surface of the copper nanoparticles by a silane coupling reaction and improves dispersibility of the composite copper particles in solvents. Examples of such silane coupling agents include alkylsilanes, acroyloxyalkylsilanes, aminoalkylsilanes, and glycidyloxyalkylsilanes which have an alkyl chain.

The alkyl chain of the silane coupling agent is preferably an alkyl chain having 10 or more carbon atoms. If the number of carbon atoms in the alkyl chain is 10 or more, the alkyl chain can exert a steric effect by bonding the silane coupling agent in an amount equivalent to forming a monomolecular film onto the surface of the copper nanoparticle.

On the other hand, if the alkyl chain is longer than necessary, it will cause an increase in carbon residue when the composite copper nanoparticles are sintered and used in electrode applications. Therefore, it is preferable that the alkyl chain of the silane coupling agent have 18 or less carbon atoms.

In the composite copper nanoparticles of the present invention, when the total mass of the composite copper nanoparticles is 100% by mass, the mass carbon concentration caused by the silane coupling agent is in a range from 0.5 to 1.2% by mass, and the mass silicon concentration is in a range from 0.05 to 0.11% by mass. When the mass carbon concentration caused by the silane coupling agent and the mass silicon concentration are within the ranges above, the surface of the copper nanoparticles is sufficiently modified with the silane coupling agent, and excellent dispersibility is achieved in solvents suitable for electrode applications.

The mass carbon concentration caused by the silane coupling agent is determined by measuring each of the mass carbon concentration of the composite copper nanoparticles and the mass carbon concentration of the copper nanoparticles in the raw material state before reaction with the silane coupling agent using the method described above, and determining by the difference between the measured value of composite copper nanoparticles and the measured value of the copper nanoparticles.

### [Mass Silicon Concentration]

The mass silicon concentration in the composite copper nanoparticles can be determined by immersing the composite copper nanoparticles in nitric acid and hydrofluoric acid to dissolve the surface of the particles, and measuring the mass silicon concentration of the solvent using an ICP emission spectrometer (for example, Hitachi High-Tech Group “Tabletop ICP Emission Spectrometer PS7800”).

Specifically, the composite copper nanoparticles are immersed in dilute hydrofluoric acid (concentration 1.5%), stirred at room temperature for 10 minutes, and a part of the supernatant liquid is collected. Thereafter, dilute nitric acid (concentration 30%) is added, stirred at room temperature for 10 minutes, and a part of the supernatant liquid is separated. Si caused by SiO₂ is liberated in the former supernatant liquid, and Si derived from Si is liberated in the latter supernatant liquid. The mass silicon concentration can be measured by diluting each liquid as necessary and measuring an emission intensity at a wavelength of 251.6 nm using ICP-AES. A calibration curve can be created using a commercially available silicon standard solution.

### (Applications)

The composite copper nanoparticles of the present invention can be used as electrode film materials for various electronic components. In particular, it is preferable to use the composite copper nanoparticles of the present invention as an electrode film material that uses an oxide or ceramic as a base material and is sintered at 300° C. or higher to form a film. Specifically, the composite copper nanoparticles of the present invention can be used, for example, as materials for electrodes in parts at which electronic components such as sensors, batteries, capacitors, and resistors are mounted on printed circuit boards.

### <Method for Producing Composite Copper Nanoparticles>

The method for producing composite copper nanoparticles of the present invention is a method for producing composite copper nanoparticles by modifying the surface of the copper nanoparticles with a silane coupling agent, the method includes a step in which copper nanoparticles having a film containing cuprous oxide and copper carbonate on at least a part of the surface thereof are produced, and a silane coupling agent is added into a dispersion liquid in which the copper nanoparticles are dispersed in an organic solvent.

### (Preparation Step)

First, as a preparation step, the copper nanoparticles having a film containing cuprous oxide and copper carbonate on at least a part of their surfaces, that is, the copper nanoparticles produced by a dry method using a reduction flame, are prepared.

The copper nanoparticles can be produced, for example, by the method described in U.S. Pat. No. 6,130,616. Moreover, if copper nanoparticles are commercially available, they may be used.

### (Dispersion Step)

Next, as a dispersion step, the copper nanoparticles are dispersed in an organic solvent to prepare a dispersion of the copper nanoparticles.

Specifically, for example, a mixture of the copper nanoparticles and the organic solvent is fed into a narrow channel under pressure, and the dispersion liquid is obtained by collision and shear force to the mixture to disperse.

When the copper nanoparticles in an organic solvent are fed into a narrow channel under pressure and dispersed by applying collision and shear force, a wet jet mill (for example, “Nanoveita B-ED” manufactured by Yoshida Kikai Kogyo, and “JN1000” manufactured by Joko) can be used.

The method for dispersing the copper nanoparticles is not limited to the above-mentioned method, and examples thereof include a method of dispersing using a rotation-revolution mixer and a method of dispersing using a blade or a roll.

The organic solvent is not particularly limited as long as it is a solvent that can disperse the copper nanoparticles. Examples of the organic solvents include polar solvents such as water; alcohols such as methanol, ethanol, 1-propanol, 2-propanol, and terpineol; polyols such as ethylene glycol, dimethylene glycol, and triethylene glycol; ethers such as diethylene glycol monobutyl ether; N, N-dimethylformamide and N-methylpyrrolidone. Among these organic solvents, alcoholic solvents such as terpineol are preferred.

### (Reaction Step)

Next, as a reaction step, the silane coupling agent is added into the dispersion of the copper nanoparticles produced, and reacted.

Specifically, the silane coupling agent is added into the dispersion of the copper nanoparticles, and the mixture is mixed and stirred using a magnetic stirrer or the like.

The amount of the silane coupling agent added into the dispersion is preferably 0.6 to 1.25 times an amount equivalent to forming a monomolecular film on the surface of the copper nanoparticles in the dispersion.

If the amount of silane coupling agent added is 0.6 times or more the amount equivalent to forming a monomolecular film on the surface of copper nanoparticles, a sufficient amount of silane coupling agent can be attached to the surface of copper nanoparticles.

By the way, when manufacturing composite copper nanoparticles by conventional technology, it was common that an excessive amount of the silane coupling agent was added into the dispersion of the copper nanoparticles in order to attach sufficient silane coupling agent to the surface of the copper nanoparticles. However, when an excessive amount of silane coupling agent was added in the dispersion liquid, the silane coupling agents reacted with each other and aggregations occurred.

On the other hand, in the method for producing composite copper nanoparticles of the present invention, the amount of the silane coupling agent added is 1.25 times or less than the amount equivalent to forming a monolayer on the surface of copper nanoparticles. Therefore, it is possible to suppress the occurrence of aggregations due to reactions between the silane coupling agent. Furthermore, the effect that unreacted silane coupling agent can be easily removed can be obtained.

Note that the amount equivalent to forming a monomolecular film refers to the amount added that causes the silane coupling agent to attach to the entire surface of the copper nanoparticles.

Specifically, the amount equivalent to forming a monomolecular film is calculated by calculating “surface area of the copper nanoparticles/occupied area of one molecule of silane coupling agent=number of molecules of silane coupling agent”, using the number of molecules of silane coupling agent and the mass per molecule of the silane coupling agent.

In the method for producing composite copper nanoparticles of the present invention, after performing the dispersion step and the reaction step explained above, the organic solvent is distilled off under reduced pressure while heating and stirring by a rotary evaporator, thereby producing powder of the composite copper nanoparticles of the present invention.

As described above, in the method for producing composite copper nanoparticles of the present invention, the reaction step may be performed after the dispersion step, or may be performed simultaneously with the dispersion step.

When performing the dispersion step and the reaction step at the same time, the silane coupling agent is added into the mixture of the copper nanoparticles and the organic solvent, the mixture is fed into the narrow channel under pressure to apply collision and shear force, and the composite copper nanoparticles are dispersed.

Since the method for producing composite copper nanoparticles of the present invention uses the copper nanoparticles produced by a dry method, it is preferable to carry out the reaction step after the dispersion step. That is, since most of the surfaces of the copper nanoparticles produced by a dry method are coated with cuprous oxide, agglomerated particles are likely to occur in an organic solvent with low polarity. Therefore, the surface of the copper nanoparticles can be efficiently modified by crushing the aggregated particles of copper nanoparticles, exposing the surface of the particles, and then adding the silane coupling agent and bringing them into contact.

As explained above, according to the composite copper nanoparticles of the present invention, the surfaces of the copper nanoparticles are modified with the silane coupling agent, so that they have high dispersibility in organic solvents. In addition, since the composite copper nanoparticles of the present invention use the copper nanoparticles produced by a dry method, there is little thermal shrinkage even after subsequent sintering at 300° C. or higher, and it is possible to form a smooth electrode film.

According to the method for producing composite copper nanoparticles of the present invention, composite copper nanoparticles which are highly dispersible in organic solvents, have little thermal shrinkage even when sintered at 300° C. or higher, and can form smooth electrode films can be produced.

Note that the technical scope of the present invention is not limited to the above-described embodiments, and various changes can be made without departing from the spirit of the present invention.

### EXAMPLES

Hereinafter, the effects of the present invention will be explained with reference to Examples, but the present invention is not limited to the configurations of the Examples.

### Example 1

### [Copper Nanoparticles]

Copper nanoparticles were produced by the production method described in Japanese Patent No. 6130616. The production conditions were as follows.
Powder raw material: Copper oxide (I) powder (manufactured by Nippon Atomize Kako Co., Ltd., average particle size: 10 μm)
Fuel gas supplied to burner: Liquefied natural gas
Combustion supporting gas: Oxygen
First cooling gas that forms a swirling flow in furnace: Nitrogen
Oxygen ratio: 0.9
Raw material supply rate: 0.36 kg/h

### [Composite Copper Nanoparticles]

In a beaker, 20 g of copper nanoparticles with an average particle size of 110 nm and a mass carbon concentration of 0.15% by mass, 55 g of ethanol, and 0.28 g (=amount equivalent to forming a monomolecular film) of octadecyltriethoxysilane (ODTES) as the silane coupling (SC) agent was added.

After dispersing the mixture with a magnetic stirrer for 10 minutes, the mixture was pressurized to a pressure of 100 MPa using “Nanovater B-ED” manufactured by Yoshida Kikai Co., Ltd., and sent into the narrow channel to be dispersed with collision and shear force. The dispersion process with shear force was repeated 10 times.

Thereafter, ethanol was distilled off under reduced pressure using a rotary evaporator immersed in a water bath at 60° C., and powder of the composite copper nanoparticle was produced.

The mass carbon concentration of the composite copper nanoparticles powder produced was measured using the method described above, a dried film was prepared as shown below, and the surface roughness of the dried film was measured.

Incidentally, the amount of octadecyltriethoxysilane equivalent to forming a monomolecular film was calculated to be 0.28 g using the following calculation formula (A).

$$Weight of octadecyltriethoxysilane to be added = \qquad ( A )$$

$$\frac{Total surface area of copper nanoparticles}{Area of one molecule of octadecyltriethoxysilane} \times$$

$$\frac{Molecular weight of octadecyltriethoxysilane}{Avogadro constant}$$

In the calculation formula (A), the area of one molecule of octadecyltriethoxysilane was 0.3 nm², the molecular weight of octadecyltriethoxysilane was 416 g/mol, and Avogadro constant was 6.02×10²³ pieces/mol.

### [Surface Roughness]

65 parts of the composite copper nanoparticles and 35 parts of a-terpineol were mixed for 2 minutes in a bead mill, and the resulting paste was coated onto a 1 cm square glass substrate using a bar coater and dried to prepare a dry film with a thickness of 15 μm.

The surface roughness of the dry film prepared was determined by measuring the surface roughness Rz at 10 points using a laser microscope (for example, “VK-110” manufactured by Keyence). The average value of 10 points was used as the surface roughness.

Note that Rz<1.0 μm is a necessary indicator for forming electrode thin films containing the composite copper nanoparticles with a thickness of 10 μm or less that are used in various electronic components.

### Example 2

Evaluation was performed in the same manner as in Example 1, except that the amount of octadecyltriethoxysilane added was changed to 0.7 times that in Example 1.

### Example 3

Evaluation was performed in the same manner as in Example 1, except that the amount of octadecyltriethoxysilane added was changed to 1.2 times that in Example 1.

### Example 4

Evaluation was performed in the same manner as in Example 1, except that decyltrimethoxysilane (DTES) was used as the silane coupling agent instead of octadecyltriethoxysilane.

### Example 5

Evaluation was performed in the same manner as in Example 1, except that copper nanoparticles with a mass carbon concentration of 0.29% by mass were used as the copper nanoparticles.

### Example 6

Evaluation was performed in the same manner as in Example 1 except that copper nanoparticles with an average particle diameter of 200 nm were used as the copper nanoparticles.

### Comparative Example 1

Evaluation was performed in the same manner as in Example 1, except that the amount of octadecyltriethoxysilane added was changed to 0.5 times that in Example 1.

### Comparative Example 2

Evaluation was performed in the same manner as in Example 1, except that the amount of octadecyltriethoxysilane added was changed to 1.5 times that in Example 1.

### Comparative Example 3

Evaluation was performed in the same manner as in Example 1, except that octyltrimethoxysilane (OTMS) was used as the silane coupling agent instead of octadecyltriethoxysilane.

### Comparative Example 4

Evaluation was performed in the same manner as in Example 1, except that copper nanoparticles with a mass carbon concentration of 0.36% by mass were used as the copper nanoparticles.

### Comparative Example 5

Evaluation was conducted in the same manner as in Example 1, except that copper nanoparticles with an average particle diameter of 250 nm were used as the copper nanoparticles.

### Comparative Example 6

Evaluation was performed in the same manner as in Example 1, except that copper nanoparticles prepared by a wet method (manufactured by Sigma-Aldrich) were used.

The results of Examples 1 to 6 are shown in Table 1 below. Further, the results of Comparative Examples 1 to 6 are shown in Table 2 below.

TABLE 1

| | Example | Example | Example | Example | Example | Example |
|---|---|---|---|---|---|---|
| | 1 | 2 | 3 | 4 | 5 | 6 |
| Average particle diameter of copper nanoparticles [nm] | 110 | 110 | 110 | 110 | 112 | 200 |
| Mass carbon concentration of copper nanoparticles [% by weight] | 0.15 | 0.15 | 0.15 | 0.15 | 0.29 | 0.08 |
| Number of carbon atoms in SC agent | C 18 | C 18 | C 18 | C 10 | C 18 | C 18 |
| SC agent used | ODTES | ODTES | ODTES | DTMS | ODTES | ODTES |
| Amount of SC agent added | 1.0 time | 0.7 times | 1.2 times | 1.0 time | 1.2 times | 1.0 time |
| (amount equivalent to forming a monomolecular film = 1.0 time) | | | | | | |
| Mass carbon concentration of composite copper particles | 0.99 | 0.90 | 1.20 | 0.67 | 1.34 | 0.61 |
| [% by weight] | | | | | | |
| Mass carbon concentration of composite copper particles | 0.84 | 0.75 | 1.05 | 0.52 | 1.05 | 0.53 |
| [% by weight] (caused by SC agent) | | | | | | |
| Mass silicon concentration of composite copper particles | 0.09 | 0.07 | 0.11 | 0.09 | 0.11 | 0.55 |
| [% by weight] | | | | | | |
| Surface roughness [μm] | 0.86 | 0.92 | 0.95 | 0.95 | 0.96 | 0.99 |

TABLE 2

| | Comp. | Comp. | Comp. | Comp. | Comp. | Comp. |
|---|---|---|---|---|---|---|
| | Example | Example | Example | Example | Example | Example |
| | 1 | 2 | 3 | 4 | 5 | 6 |
| Average particle diameter of copper nanoparticles [nm] | 110 | 110 | 110 | 115 | 250 | 60 |
| Mass carbon concentration of copper nanoparticles | 0.15 | 0.15 | 0.15 | 0.36 | 0.06 | <0.01 |
| [% by weight] | | | | | | |
| Number of carbon atoms in SC agent | C 18 | C 18 | C 8 | C 18 | C 18 | C 18 |
| SC agent used | ODTES | ODTES | OTMS | ODTES | ODTES | ODTES |
| Amount of SC agent added | 0.5 time | 1.5 times | 1.0 times | 1.0 time | 1.0 times | 1.0 time |
| (amount equivalent to forming a monomolecular film = 1.0 time) | | | | | | |
| Mass carbon concentration of composite copper particles | 0.63 | 1.58 | 0.59 | 0.85 | 0.48 | 1.71 |
| [% by weight] | | | | | | |
| Mass carbon concentration of composite copper particles | 0.48 | 1.43 | 0.44 | 0.49 | 0.42 | 1.71 |
| [% by weight] (caused by SC agent) | | | | | | |
| Mass silicon concentration of composite copper particles | 0.05 | 0.14 | 0.09 | 0.09 | 0.04 | <0.01 |
| [% by weight] | | | | | | |
| Surface roughness [μm] | 1.71 | 2.24 | 2.73 | 1.84 | 2.55 | 1.77 |

### <Evaluation 1>

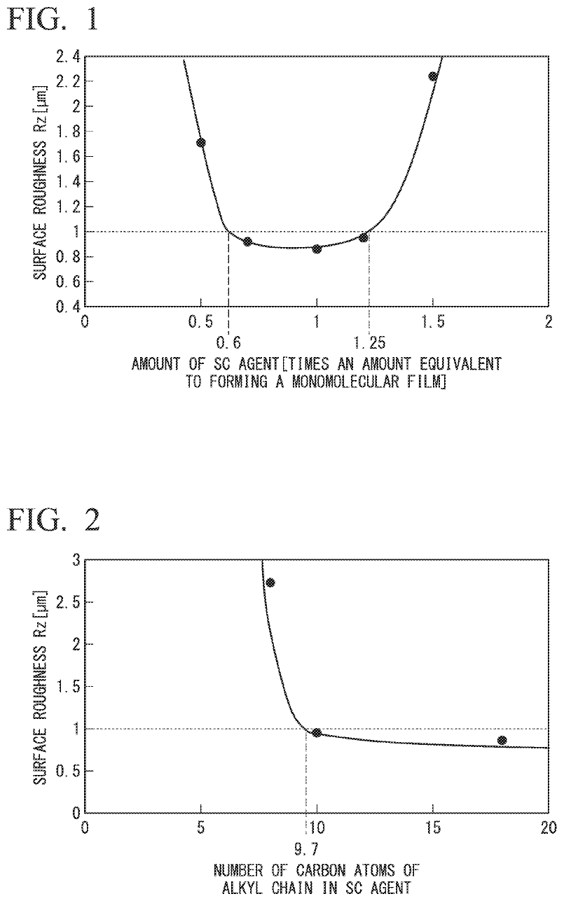

FIG. 1 is a graph showing the relationship between the amount of the silane coupling agent added and the surface roughness Rz in Examples 1 to 3 and Comparative Examples 1 and 2 described above. In FIG. 1, the X axis is the amount of the silane coupling agent added in terms of the amount equivalent to forming a monomolecular film, and the Y axis is the surface roughness Rz in the dry film prepared.

As shown in FIG. 1, it was confirmed from the intersection of the approximate curve derived from the results of Examples 1 to 3 and Comparative Examples 1 and 2 and the straight line of surface roughness Rz=1.0 μm that when the amount of the silane coupling agent added is 0.6 to 1.25 times, the surface roughness Rz is less than 1.0 μm, and when the amount of the silane coupling agent added is less than 0.6 times and more than 1.25 times, the surface roughness Rz is 1 μm or more.

### <Evaluation 2>

FIG. 2 is a graph showing the relationship between the number of carbon atoms in the alkyl chain of the silane coupling agent and the surface roughness Rz in Examples 1 and 4 and Comparative Example 3 described above. In FIG. 2, the X axis is the number of carbon atoms in the alkyl chain of the silane coupling agent, and the Y axis is the surface roughness Rz in the dry film prepared.

As shown in FIG. 2, it was confirmed from the intersection of the approximate curve derived from the results of Examples 1 and 4 and Comparative Example 3 and the straight line of surface roughness Rz=1.0 μm that the number of the carbon atoms in the alkyl chain of the silane coupling agent is 9.7, which is the limit for whether or not the surface roughness Rz can reach less than 1.0 μm. That is, it was confirmed that a surface roughness Rz of less than 1.0 μm can be achieved by using a silane coupling agent of which the alkyl chain has 10 or more carbon atoms. On the other hand, it is suggested that when a silane coupling agent having an alkyl chain carbon number of 9 or less is used, the surface roughness Rz becomes 1.0 μm or more.

### <Evaluation 3>

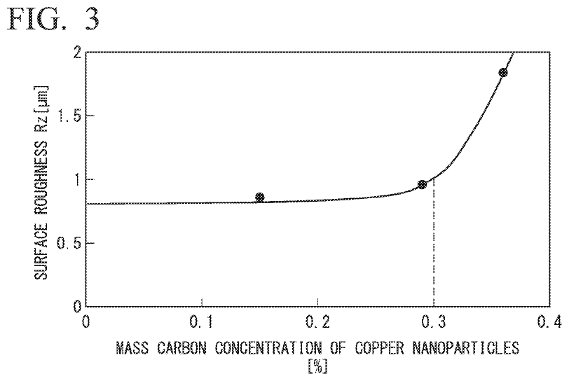

FIG. 3 is a graph showing the relationship between the mass carbon concentration of the copper nanoparticles and the surface roughness Rz in Examples 1 and 5 and Comparative Example 4 described above. In FIG. 3, the X axis is the mass carbon concentration of the copper nanoparticles, and the Y axis is the surface roughness Rz of the dry film prepared.

As shown in FIG. 3, it was confirmed from the intersection of the approximate curve derived from the results of Examples 1 and 5 and Comparative Example 4 and the straight line of the surface roughness Rz=1.0 μm that when the mass carbon concentration of the copper nanoparticles is 0.3% by mass or less, the surface roughness Rz is less than 1.0 μm, and that when the mass carbon concentration of the copper nanoparticles exceeds 0.3% by mass, the surface roughness Rz is 1.0 μm or more.

1. Composite copper nanoparticles in which a surface of copper nanoparticles is modified with a silane coupling agent,
wherein the copper nanoparticles have a film containing cuprous oxide and copper carbonate on at least a part of the surface thereof,
wherein when a total mass of the composite copper nanoparticles is 100% by mass, a mass carbon concentration is in a range from 0.5 to 1.5% by mass,
wherein a mass carbon concentration caused by the silane coupling agent in the mass carbon concentration is in a range from 0.5 to 1.2% by mass, and
wherein when a total mass of the composite copper nanoparticles is 100% by mass, a mass silicon concentration is in a range from 0.05 to 0.11% by mass.

2. The composite copper nanoparticles according to claim 1, wherein a mass carbon concentration caused by the copper nanoparticles in the mass carbon concentration is 0.3% by mass or less.

3. The composite copper nanoparticles according to claim 1, wherein the silane coupling agent has an alkyl chain having 10 or more carbon atoms.

4. The composite copper nanoparticles according to claim 1, wherein an average particle diameter of the copper nanoparticles is 200 nm or less.

5. A method for producing composite copper nanoparticles by modifying the surface of the copper nanoparticles with a silane coupling agent,
the method comprising:
a copper nanoparticles preparation step in which copper nanoparticles having a film containing cuprous oxide and copper carbonate on at least a part of the surface are prepared;
a dispersion step in which a dispersion liquid in which the copper nanoparticles are dispersed in an organic solvent is prepared; and
a reaction step in which a silane coupling agent is added into the dispersion liquid.

6. The method for producing composite copper according to claim 5,
wherein an amount of the silane coupling agent added is 0.6 to 1.25 times an amount equivalent to forming a monolayer film on the surface of the copper nanoparticles.
